(19) United States
(12) Patent Application Publication
(10) Pub. No.: US 2006/0271732 A1
(43) Pub. Date: Nov. 30, 2006

(54) Information recording device and method for initializing the same

(75) Inventor: Kazuhiko Muguruma, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/438,365

(22) Filed: May 23, 2006

(30) Foreign Application Priority Data
May 31, 2005 (JP) 2005-160664

(51) Int. Cl. G06F 13/28

(52) U.S. Cl. 711/112

(57) ABSTRACT

According to one embodiment, there is provided an information recording device including a recording unit 18 which records information in a plurality of storage areas obtained by separating one recording medium by a plurality of continuous areas A to E and reproduces the information, a determining unit which determines whether or not a predetermined condition is satisfied, and a control unit which, when it is determined that the predetermined condition is satisfied, performs a control to transfer information recorded in a storage area of one continuous area among the plurality of continuous areas to another storage area, and then initialize the storage area of the one continuous area. Automatic initialization for each continuous region makes it possible to avoid fragmentation of information (file), so that the high speed access process immediately after purchase can be retained.

### CROSS-REFERENCE TO RELATED APPLICATIONS

This application is based upon and claims the benefit of priority from Japanese Patent Application No. 2005-160664, filed May 31, 2005, the entire contents of which are incorporated herein by reference.

### BACKGROUND

1. Field

One embodiment of the present invention relates to an information recording device using a hard disk drive or the like, and more specifically, to an information recording device which performs initialization to each of continuous areas (partitions and the like) in a disk, and a method of initializing the same.

2. Description of the Related Art

In recent years, along the spread of digital devices, an information recording device using a hard disk recorder or the like has been used generally, and made it possible to recording and reproducing more video information than the record and reproduction processes by a conventional video tape recorder (VTR). In such an information recording device, there occurs fragmentation owing to distribution of video information files when the recording process and reproducing process are continued repeatedly for a long time, which causes a problem that the processing speed decreases.

To cope with this problem, Patent Document 1 (Jpn. Pat. Appln. KOKAI Publication No. 2001-157151) provides a video recording device which makes it possible to record video without influence of fragmentation at necessity by arranging and utilizing an emergency video recording area in order to avoid fragmentation.

However, in the prior art disclosed in Patent Document 1, it is necessary to maintain the emergency video recording area, selectively store video that requires a response thereto and secure accessibility at an emergency, and then transfer the video to a recording area for storage. Accordingly, so long as recording is performed by this method, the emergency video recording area will get full if the transfer from the emergency video recording area to a normal recording process is not always performed, which has been a problem with the prior art.

Further, apart from the above method, a user must perform a formatting process arbitrarily by a general formatting process of a hard disk drive, which causes burdens to the user. Furthermore, if the user does not perform the formatting process at all even when fragmentation occurs, the access process decreases gradually, and the high speed access process at the time of purchase cannot be attained, which has been another problem with the prior art.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A to 1C are explanatory diagrams for explaining a basic operation of an information processing device according to one embodiment of the present invention;

FIG. 2 is an explanatory diagram for explaining an example of a formatting operation of an information processing device according to one embodiment of the invention;

FIG. 3 is an explanatory diagram for explaining another example of the formatting operation of the information processing device according to one embodiment of the invention;

FIG. 4 is an explanatory diagram for explaining further another example of the formatting operation of the information processing device according to one embodiment of the invention;

FIG. 5 is a block diagram showing an example of a configuration of the information processing device according to one embodiment of the invention;

FIG. 6 is a flow chart for explaining an example of a formatting operation (without returning data) of the information processing device according to one embodiment of the invention;

FIG. 7 is a flow chart for explaining an example of a formatting operation (with returning data) of the information processing device according to one embodiment of the invention;

FIG. 8 is a flow chart for explaining an example of a formatting operation (distribution degree monitoring) of the information processing device according to one embodiment of the invention;

FIG. 9 is a flow chart for explaining an example of a formatting operation (desired timing) of the information processing device according to one embodiment of the invention;

FIG. 10 is a flow chart for explaining an example of a formatting operation (exclusive partition) of the information processing device according to one embodiment of the invention;

FIG. 11 is a flow chart for explaining an example of a formatting operation (storage area on network) of the information processing device according to one embodiment of the invention; and

FIG. 12 is a flow chart for explaining an example of a formatting operation (file deletion) of the information processing device according to one embodiment of the invention.

### DETAILED DESCRIPTION

Various embodiments according to the present invention will be described hereinafter with reference to the accompanying drawings. In general, according to one embodiment of the present invention, there is provided an information recording device comprising: a recording unit which records information in a plurality of storage areas obtained by separating one recording medium by a plurality of continuous areas and reproduces the information; a determining unit which determines whether or not a predetermined condition is satisfied; and a control unit which, when the determining unit determines that the predetermined condition is satisfied, performs a control to transfer information recorded in a storage area of one continuous area among the plurality of continuous areas to another storage area, and then initialize the storage area of the one continuous area.

In the above-mentioned information recording device, files are evacuated to another storage area when one of the storage areas of the plurality of continuous areas (partitions, or, areas where continuity is guaranteed in one partition) satisfies a predetermined condition (predetermined processing speed, predetermined time) or the like. Then, the storage area is initialized by formatting or the like, and thereby a high speed processing speed is maintained.

Hereinafter, this embodiment of the present invention will be explained in more detail with an example of an information recording device as a hard disk recorder with reference to the accompanying drawings.

### One Embodiment of the Present Invention

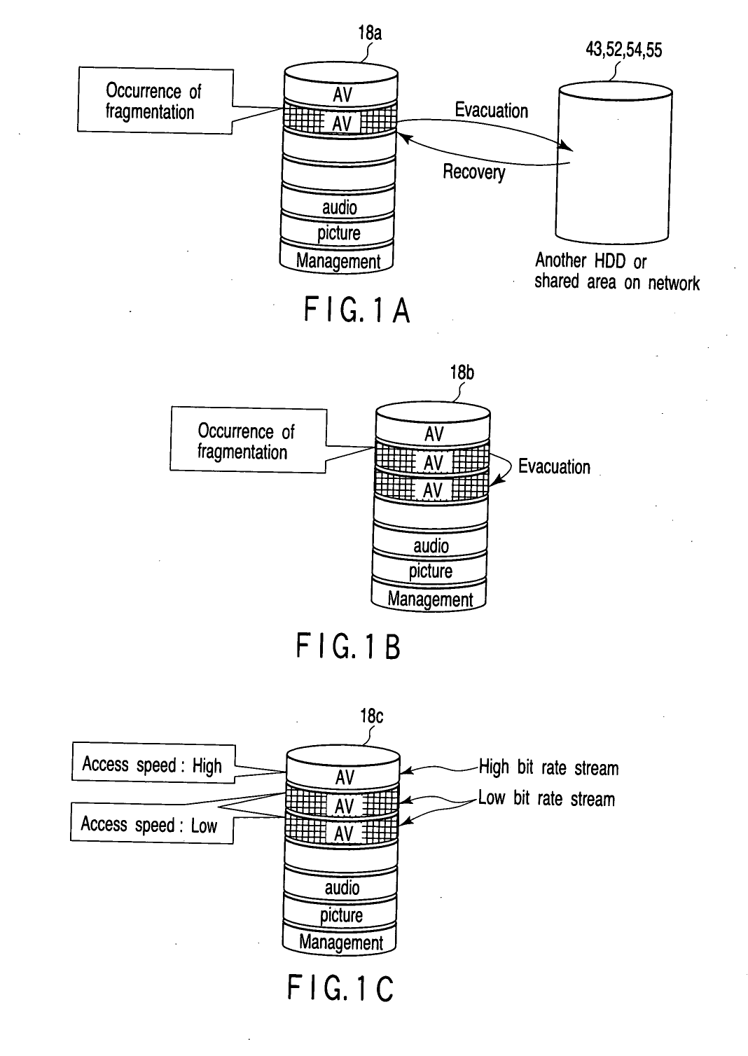

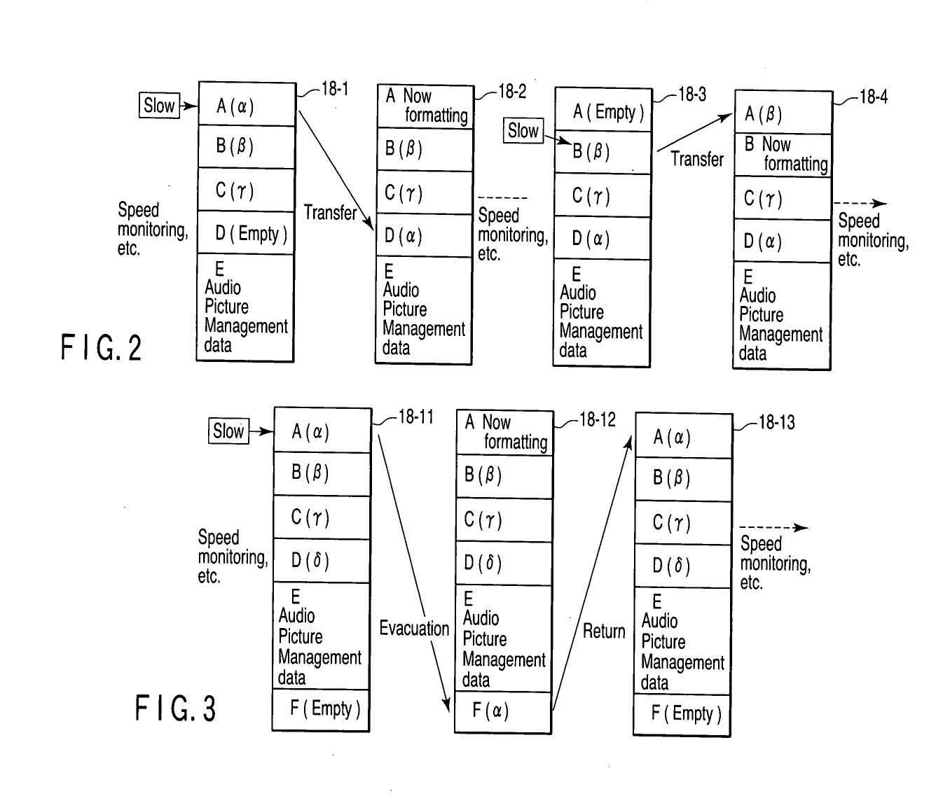

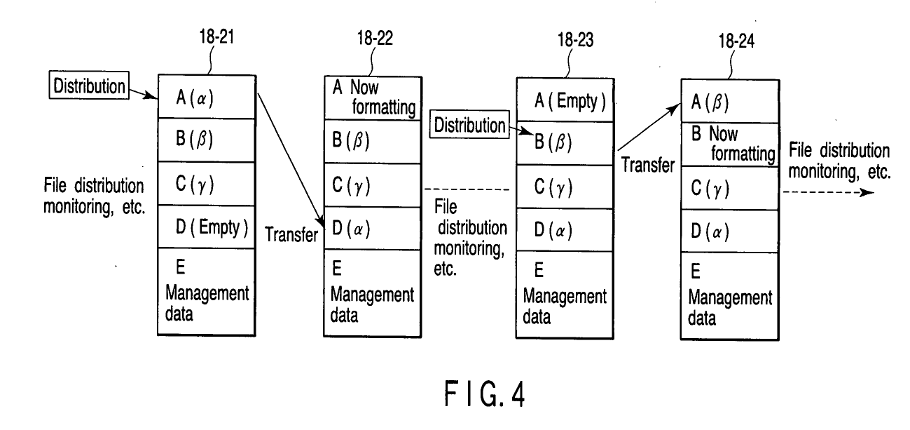

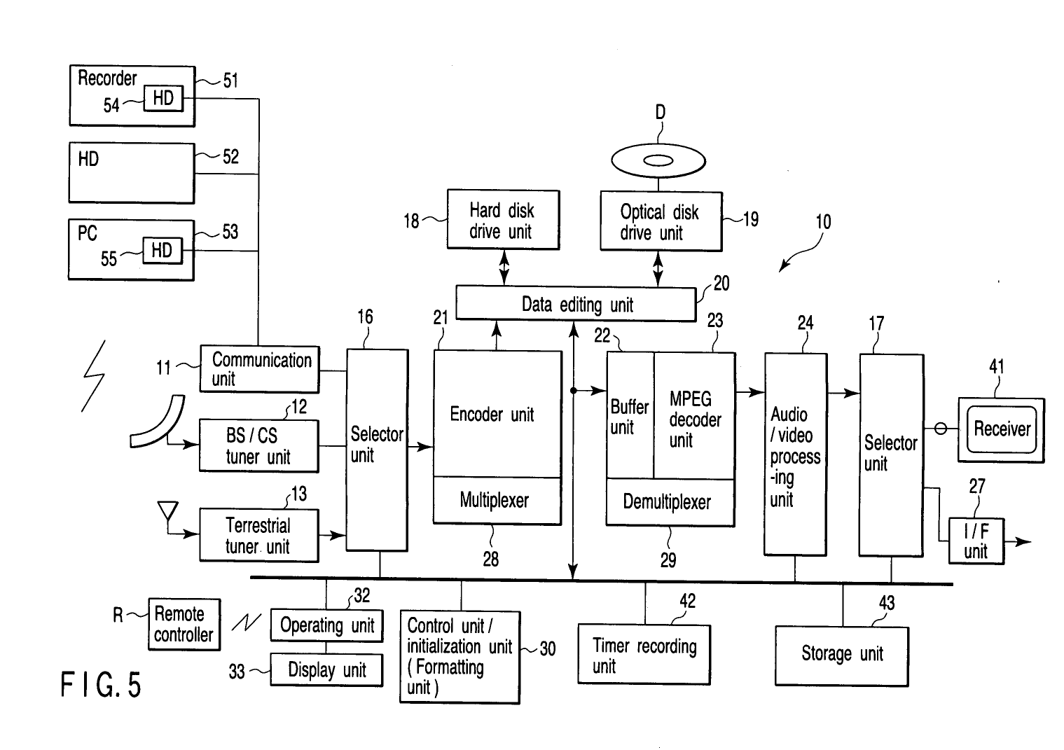

First, FIGS. 1A to 1C are explanatory diagrams for explaining a basic operation of an information processing device according to one embodiment of the present invention. FIG. 2 is an explanatory diagram for explaining an example of a formatting operation of the information processing device according to one embodiment of the invention. FIG. 3 is an explanatory diagram for explaining another example of the formatting operation of the information processing device according to one embodiment of the invention. FIG. 4 is an explanatory diagram for explaining further another example of the formatting operation of the information processing device according to one embodiment of the invention. FIG. 5 is a block diagram showing an example of a configuration of the information processing device according to one embodiment of the invention.

(Configuration)

Herein, an information recording device 10, as shown in FIG. 1, evacuates files and performs initialization such as formatting when fragmentation occurs. As described later in FIGS. 2 to 4, the information recording device evacuates files, and performs initialization such as formatting to each of continuous areas (partitions, or areas where continuity is guaranteed in one partition). In the embodiment of the invention, the continuous areas are not limited to partitions, but they may be areas where continuity is guaranteed in one partition, or the like. However, in embodiments hereinafter, explanations will be made with the case of partitions as an example.

Such an information recording device 10 includes, as shown in FIG. 5, for example, an optical disk drive unit 19 as an information recording medium that can configure video files, and a hard disk drive unit 18 that drives a hard disk. A control unit (initializing unit/formatting unit) 30 is connected to respective units via a data bus so as to control the entire operation. Further, the information recording device 10 in FIG. 1 includes an encoder unit 21 that configures a recording side, an MPEG decoder unit 23 that configures a replaying side, and the control unit (initializing unit/formatting unit) 30 that controls the operation of the device main body as its main components.

(Operation)

Next, an operation of the information recording device 10 having such a configuration will be explained in more detail hereinafter. As the input side of the information recording device 10, a communication unit 11 such as a LAN connects to an external device. The communication unit communicates with a program information provision server S and the like via a channel such as Internet via, for example, a modem M or the like, and downloads content information and the like. Further, a BS/CS tuner unit 12 and a terrestrial tuner unit 13 select broadcasting signals via an antenna and demodulate them to input video signals and audio signals, and correspond to wide kinds of broadcasting signals. The BS/CS tuner unit 12 and the terrestrial tuner unit 13 correspond to, for example, analog terrestrial broadcasting, digital terrestrial broadcasting, BS analog broadcasting, BS digital broadcasting, CS digital broadcasting and the like, but not limited thereto. Further, the present invention is not limited to the case wherein only one unit of each of them is provided, but the information includes the case in which, for example, two or three units of analog terrestrial broadcasting tuner units, and BS/CS tuner units are provided and made to function according to a request for timer recording.

The above communication unit 11 may be a LAN or an IEEE1394 interface, and can receive digital contents from an external device on a network. Furthermore, the communication unit may receive brightness signals and color difference signals, video signals and audio signals such as composites from an input terminal (not shown). The input of the signals is controlled by a selector 16 controlled by the control unit (initializing unit/formatting unit) 30 or the like, and selectively supplied to the encoder unit 21.

The encoder unit 21 includes: video and audio analog digital converters that digitalize analog video signals and analog audio signals input from the selector 16; a video encoder; and an audio encoder. The encoder unit 21 also includes a sub video encoder. The output of the encoder unit 21 is converted into a predetermined compression format such as MPEG, and supplied to the control unit (initializing unit/formatting unit) 30.

Further, the BS/CS tuner 12 and the like are not always necessary to be built in, but it is preferable that they are arranged externally via a data input terminal, and supply received digital signals via the selector unit 16 to the encoder unit 21 and the control unit (initializing unit/formatting unit) 30.

Herein, the device in FIG. 1 can supply information (packs of video, audio, sub video data and the like) encoded by the encoder unit 21 and prepared management information via the control unit (initializing unit/formatting unit) 30 to the hard disk drive unit 18 (or the optical disk drive unit 19), and can record them in the hard disk drive unit 18 (or, an optical disk D). In addition, the information recorded in the hard disk drive unit 18 or the optical disk D can be recorded in the optical disk D or the hard disk drive unit 18 via the optical disk drive unit 19 by the control unit (initializing unit/formatting unit) 30.

Further, digital broadcasting can be recorded without being encoded again, and in this case, a recording process is performed in the order of the selector unit 16, a separating unit 29, the hard disk drive unit 18, and the optical disk drive unit 19.

A data editing unit 20 can perform an editing process in which video objects of plural broadcasting programs recorded in the hard disk drive unit 18 or the optical disk D are partially deleted, or objects of different broadcasting programs are added, and the like.

Next, the process of reproducing recorded information will be mainly explained in detail together with other embodiments hereinafter. The MPEG decoder unit 23 includes a video processor that appropriately composes decoded sub video to decoded main video, and displays menus, highlight buttons, captions and other sub video on the main video.

Output audio signals of the MPEG decoder unit 23 are analog-converted by a digital-analog converter (not shown) via a selector unit 17, and supplied to a speaker or supplied to an external device via an I/F unit 27. The selector unit 17 is controlled by select signals from the control unit (initializing unit/formatting unit) 30. Thereby, when directly monitoring digital signals from the respective tuners 12 and 13, the selector unit 17 can also directly select signals having passed through the encoder unit 21.

The information recording device 10 according to the present embodiment has comprehensive functions as mentioned above, and performs recording and reproducing processes by the optical disk D or the hard disk drive unit 18 with respect to many sources. Next, initialization and the like of the hard disk drive unit 18 of the information recording device 10 will be explained in detail with reference to the accompanying drawings.

<Initialization and the Like of Hard Disk Drive Unit>

Next, initialization and the like of the hard disk drive unit or the like according to one embodiment of the present invention will be explained in detail with reference to the accompanying drawings. First, the outline is explained, and an example of an initializing function of the information recording device 10 according to the embodiment of the invention is such that, as shown in FIG. 1A, a file is evacuated to an external storage area 43 and HDs 54 and 55 of devices 51, 52 and 53 on a network, and initialization such as formatting is performed to recover this file. As another example, as shown in FIG. 1B, the information recording device evacuates a file in the storage area of a partition of a same recording medium 18b to a storage area of another partition of the same recording medium 18b, and performs initialization such as formatting to the storage area of the partition. As farther another example, as shown in FIG. 1C, the information recording device distinguishes a high bit rate from a low bit rate, and performs initialization such as formatting while performing evacuation and recovery of a file between same bit rates. Next, more detailed explanation will be made with a flow chart and transition diagrams of FIGS. 2 to 4 hereinafter.

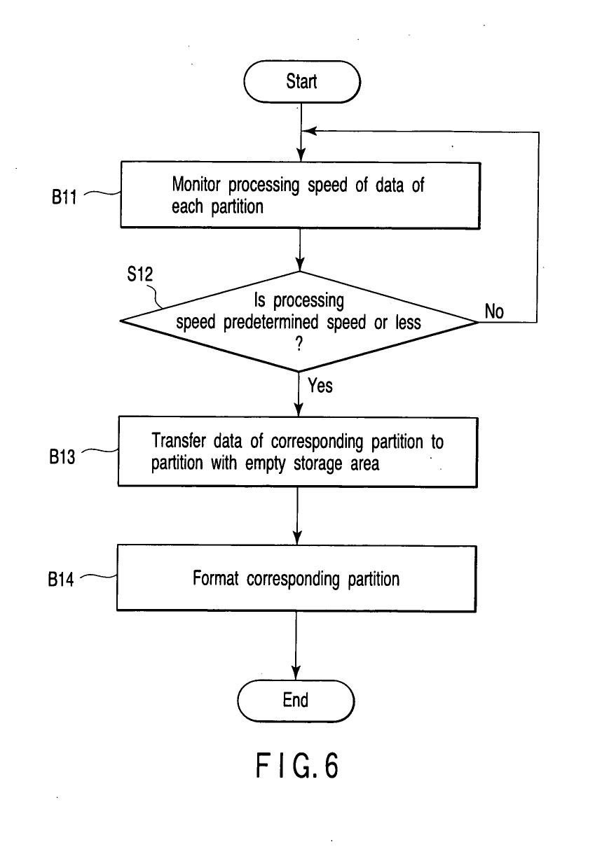

(Case without Returning Data: FIG. 6)

In a hard disk drive unit or the like according to one embodiment of the present invention, first, an access speed of reading and the like of a file stored in a storage area of each partition is always monitored in a normal action state under the control of the control unit 30 in FIG. 1 or the like (block B11). When this access speed (reading speed) as a processing speed becomes a predetermined speed or less, a storage area (for example, storage area A in FIG. 2) of a partition A of the hard disk drive unit 18-1 is to be initialized, and a stored motion picture file “a” and the like are moved to a storage area D of another partition, as shown in FIG. 2 (block B13). Thereafter, this partition A is initialized (formatted, or, only deleting a motion picture file or the like is also available, as described later herein) (block B14). In this manner, it is possible to avoid fragmentation, and keep the storage area of the hard disk drive unit 18 at a state near to that at the time of purchase. At this moment, it is preferable to display a warning to a user, and it is preferable to make a warning, prompt an instruction, and wait for an instruction for initialization from the user to perform these processes.

Further, it is preferable that with regard to the user instructions, a run time zone is preset and processed automatically, such as “process start at once”, “reservation by time designation”, and “automatic determination according to operating condition”.

As a consequence, in the information processing device according to the present invention, the storage area is automatically initialized per each of plural partitions without obtaining the user's instruction. For this reason, fragmentation can be avoided without giving burdens to the user like the prior-art device, and therefore, it is possible to always perform an access process to the pleasant hard disk drive unit at the time of purchase.

Herein, it is preferable to record audio files, picture files, and management data in the storage area of an independent partition E, and separate them from files of other motion picture information and the like. This makes it possible to prevent a nonconformity of a decreased processing speed even if there are motion picture files, still images and audio files in mixture.

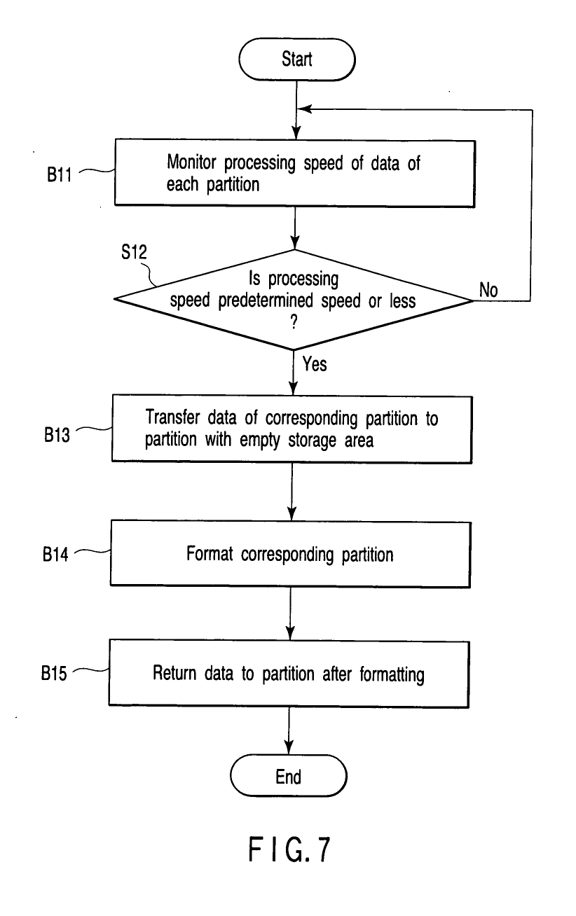

(Case with Returning Data: FIG. 7)

Next, in the flow chart in FIG. 7, it is preferable that, as shown in the explanatory diagram in FIG. 3, when it is determined that there is a problem with an access speed in a predetermined area (block B11, B12), a motion picture file “a” and the like are moved to an empty area F or the like (block B13), and after initialization (formatting, or deleting a file or the like to be described later) is performed (block B14), the motion picture file “a” and the like are returned and recovered from the storage area F or the like to the storage area A of a partition after formatting (block B15). Consequently, the position of the motion picture file does not change at every initialization, which makes the file management easy.

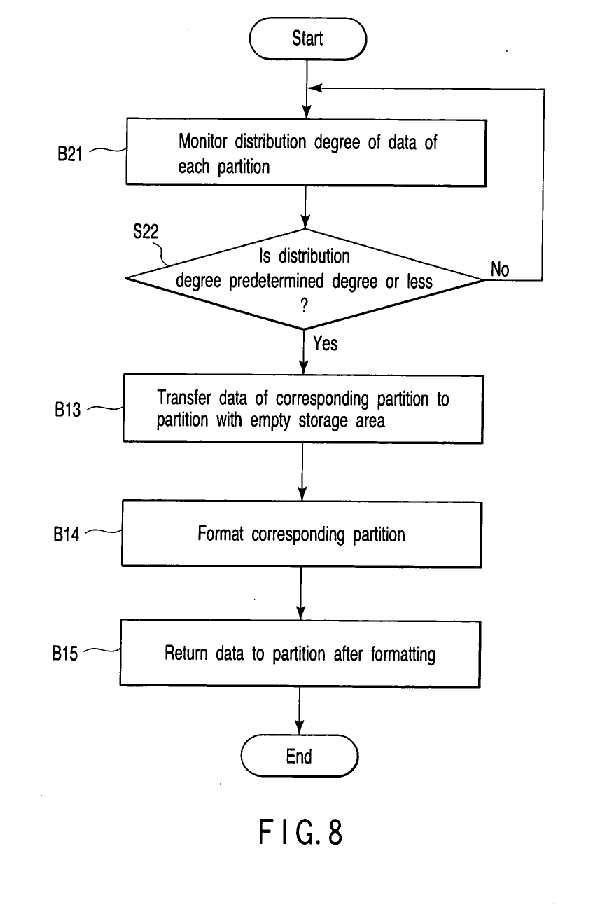

(Case of File Distribution Degree Monitoring: FIG. 8)

Next, in the flow chart in FIG. 8, a distribution degree of a file in a storage area per partition is directly measured as shown in the explanatory diagram in FIG. 4 (block B21). If a distribution degree of the file proceeds over a predetermined value in the place of the above-mentioned access speed, it is determined that initialization is necessary (block B22). Then, a subsequent file transfer process (block B13), an initialization process for a storage area of partition (block B14), and further, data of a motion picture file or the like are recovered to a storage area after initialization as necessity (block B15).

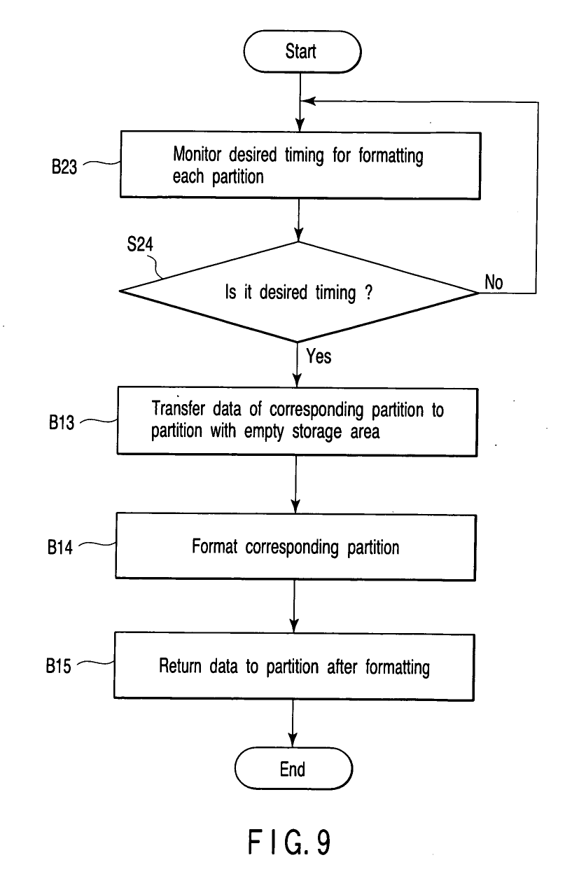

(Case of Desired Timing Monitoring: FIG. 9)

Next, in the flow chart in FIG. 9, a trigger of an initialization process is given by a time counting function provided in the control unit 30 of the information recording device 10. Namely, such a trigger as automatically detects a decrease of the access speed is not used. For example, in the case of a hard disk recorder, there is set time of 20 minutes or the like from four o'clock in the early morning on Monday when the user uses it least, and time is always monitored (block B23). Then, when it is detected that this time is reached (block B24), the above initialization process per partition is performed (blocks B13 to B15).

Thus, as shown in, for example, the explanatory diagram in FIG. 3, initialization per partition in the order is performed according to a plan, whereby storage areas of all the partitions of all the hard disk drive units 18 are initialized, for example, in a week (a month or the like). All the file information such as motion picture information stored in advance are not changed at all.

As a consequence, it is possible to always maintain the hard disk drive unit in a state where fragmentation is eliminated as well as the state at the time of purchase while the user does not notice without giving burdens to the user's operation. Accordingly, a high speed access almost at the same level as that at the time of purchase is possible for ever.

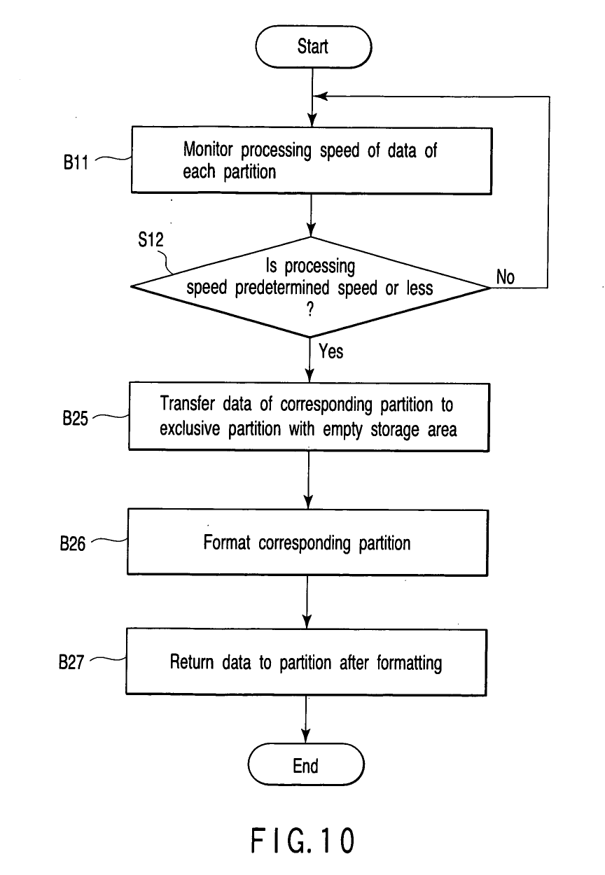

(Case using Exclusive Partition: FIG. 10)

Further, in the flow chart in FIG. 10 and the explanatory diagram in FIG. 3, a file “a” of motion picture information and the like are evacuated in advance by use of an exclusive partition F (FIG. 3) exclusive for evacuation (block B25). After initialization such as formatting (block B26), data is recovered to the area after this initialization (formatting) (block B27). By arranging the partition exclusive for evacuation as described above, it is possible to perform data evacuation and initialization (formatting), and data recovery in more stable manners, so that it is possible to perform a further precise automatic initialization process.

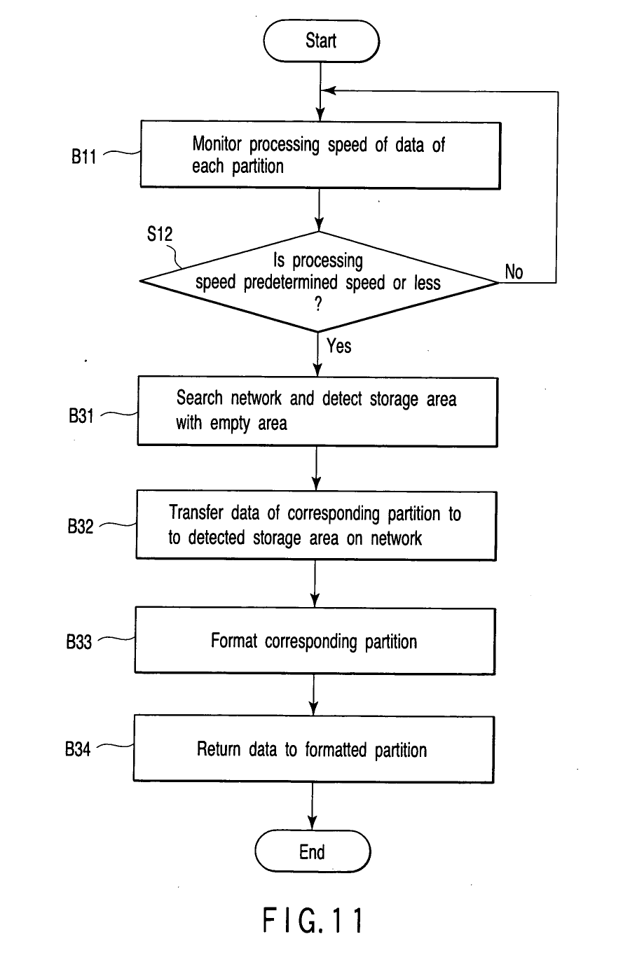

(Case of Storage Area on Net: FIG. 11)

Further, in the flow chart in FIG. 11 and FIG. 5, it is preferable that the evacuation place of the file “a” of motion picture information and the like is set to the storage unit 43 as a storage area which is another storage area in the device, or storage areas 54, 52 and 55 of external devices 51, 52 and 43 available via the network.

Namely, since there is no need to obtain an evacuation place in the hard disk drive unit 18 by obtaining a file evacuation place in the outside, it is possible to initialize each area of the hard disk drive unit 18 sufficiently. Namely, when it is determined that a transfer is necessary (blocks B11, B12), the necessary data transfer amount is calculated. In order to seek for a storage area to meet the transfer amount, an empty area in the external devices 51, 52 and 53 on the network is detected via the communication unit 11 or the like (block B31). Thereafter, a data transfer process (block B32) is performed to the detected area, and an initialization process (formatting process) for the corresponding partition is performed (block B33), and a recovery process for data after formatting is performed (block B34).

Further, all of the storage areas on the network, storage areas of the hard disk drive unit 18, and the storage unit 43 in the device are searched as candidates, and one of these accessible at the highest speed is determined as an evacuation destination.

Furthermore, it is preferable that not necessarily one storage area but plural storage areas are selected as evacuation destinations, and a motion picture file and the like are separately evacuated.

Moreover, as shown in FIG. 1C, it is preferable that the processing speed of the storage area of each partition is measured, and a stream of a high bit rate is re-arranged to a partition of a short processing time while a stream of a low bit rate is re-arranged to a partition of a long processing time, thereby suppressing the decrease of the entire processing speed.

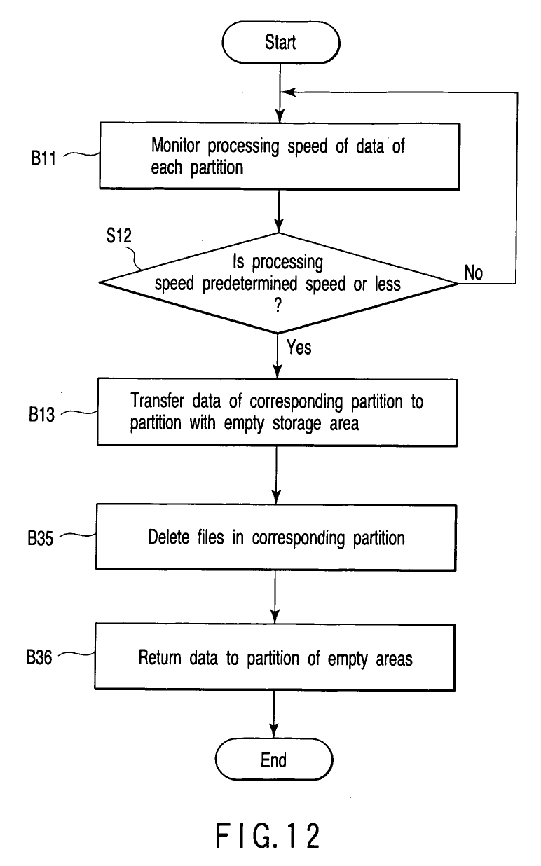

(Case of Initialization by File Deletion: FIG. 12)

Further, in the flow chart in FIG. 12, a formatting process per partition is not performed, but a method of deleting all the files in an area is employed with regard to the above-mentioned initialization process (blocks B35 and B36). Thereby, it is possible to greatly shorten the time for initialization. Thus, initialization is possible easily at necessity, so that it is possible to automatically realize a further higher speed of the processing speed.

In addition, in the embodiments according to the present invention, similar functions and effects are obtained even with another method of initializing a storage area, and the present invention expands to a wide range without departing from the principle and novel features disclosed herein, and is not limited to the embodiments described above.

By the various embodiments described above, those skilled in the art may realize the present invention, and further may think of various modifications of these embodiments, and may apply them to various embodiments even without having an inventive capability. Accordingly, the present invention expands to a wide range without departing from the principle and novel features disclosed herein, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording device comprising:
a recording unit which records information in a plurality of storage areas obtained by separating one recording medium by a plurality of continuous areas and reproduces the information;
a determining unit which determines whether or not a predetermined condition is satisfied; and
a control unit which, when the determining unit determines that the predetermined condition is satisfied, performs a control to transfer information recorded in a storage area of one continuous area among said plurality of continuous areas to another storage area, and then initialize the storage area of said one continuous area.

2. An information recording device according to claim 1, wherein the control unit control so as to initialize the storage areas by formatting the same.

3. An information recording device according to claim 1, wherein the determining unit determines that a recording process or reproducing process of the recording unit has decreased to a predetermined speed or less as the predetermined condition.

4. An information recording device according to claim 1, wherein the control unit controls so as to record the information transferred to the another storage area again to the storage area after the initialization of the storage area.

5. An information recording device according to claim 1, wherein the determining unit determines that a distribution degree of information recorded in said plurality of storage areas separated by said plurality of continuous areas has become a predetermined degree or more as the predetermined condition.

6. An information recording device according to claim 1, wherein the determining unit determines that a current time and date has become a preset time and date as part or whole of the predetermined condition.

7. An information recording device according to claim 1, wherein, when the information is moved so as to be evacuated, the control unit moves the information to the storage area of preset continuous areas exclusive for evacuation.

8. An information recording device according to claim 1, wherein, when the information is moved so as to be evacuated, the control unit searches for storage areas of external devices existing on a network via a communication unit, and moves the information to one of the storage areas.

9. An information recording device according to claim 1, wherein the control unit initializes the storage areas of the continuous areas by deleting all the plural items of information recorded in the storage areas of the continuous areas.

10. An information recording device according to claim 1, wherein the recording unit records motion picture information, and audio information and still image information in storage areas of different continuous areas, respectively.

11. A method of initializing an information recording device, comprising:
recording information in a plurality of storage areas obtained by separating one recording medium by a plurality of continuous areas;
determining whether or not a predetermined condition is satisfied; and
when it is determined that the predetermined condition is satisfied, performing a control to transfer information recorded in a storage area of one continuous area among said plurality of continuous areas to another storage area, and then initialize the storage area of said one continuous area.

12. A method of initializing an information recording device, according to claim 11, further comprising:
controlling so as to initialize the storage areas by formatting the same.

13. A method of initializing an information recording device, according to claim 11, wherein, in the determination, it is determined that a processing speed of the recording process has decreased to a predetermined speed or less as the predetermined condition.

14. A method of initializing an information recording device, according to claim 11, further comprising:
controlling so as to record the information transferred to the another storage area again in the storage area after the initialization of the storage area.

15. A method of initializing an information recording device, according to claim 11, wherein in the determination, it is determined that a distribution degree of information recorded in said plurality of storage areas separated by said plurality of continuous areas has become a predetermined degree or more as the predetermined condition.

16. A method of initializing an information recording device, according to claim 11, wherein in the determination, it is determined that a current time and date has become a preset time and date as part or whole of the predetermined condition.

17. A method of initializing an information recording device, according to claim 11, wherein, when the information is moved so as to be evacuated, the information is moved to the storage area (F in FIG. 3) of preset continuous areas exclusive for evacuation.

18. A method of initializing an information recording device, according to claim 11, wherein, when the information is moved so as to be evacuated, storage areas of external devices existing on a network are searched for by making a communication via the network, and the information is moved to one of the storage areas.

19. A method of initializing an information recording device, according to claim 11, further comprising:
initializing the storage areas of the continuous areas by deleting all the plural items of information recorded in the storage areas of the continuous areas.

20. A method of initializing an information recording device, according to claim 11, wherein, in the information recording process, motion picture information, and audio information and still image information are recorded to storage areas of different continuous areas, respectively.
